(19) United States
(12) Patent Application Publication
(10) Pub. No.: US 2008/0238027 A1
(43) Pub. Date: Oct. 2, 2008

(54) BICYCLE FRAME COMPONENT

(75) Inventor: Jan Talavasek, Morgan Hill, CA (US)

Correspondence Address: KNOBBE MARTENS OLSON & BEAR LLP, 2040 MAIN STREET, FOURTEENTH FLOOR, IRVINE, CA, 92614, US

(73) Assignee: SPECIALIZED BICYCLE COMPONENTS, INC., Morgan Hill, CA (US)

(21) Appl. No.: 11/692,116

(22) Filed: Mar. 27, 2007

(51) Int. Cl. B62K 3/02; B21D 39/04

(52) U.S. Cl. 280/281.1; 29/282

(57) ABSTRACT

A bicycle frame component that comprises a cavity sized and shaped to receive a stay. The cavity includes a mounting interface, which comprises a top surface, a bottom surface, a first side surface, a second side surface, and an end surface. The first side surface and the second side surface are capable of permitting lateral rotation of the stay in a first rotational direction and opposing lateral rotation of the stay in a second rotational direction opposite the first rotational direction. The end surface is capable of axially supporting the stay.

### BACKGROUND OF THE INVENTION

1. Field of the Invention

The present invention generally relates to bicycles and, more specifically, to joining of components of a bicycle frame.

2. Description of the Related Art

One type of bicycle frame is an assembly of multiple components assembled together into a desired shape. The individual components of such a bicycle frame may comprise metal tubes that are cut, shaped and joined together, typically by a welding process and/or composite tubes that are cut, shaped and bonded together typically using adhesive. In general, a bicycle frame is configured to support a seat assembly, a pedal crank assembly, a rear wheel and a steering assembly. The steering assembly typically includes a handlebar, front fork and front wheel coupled to one another and permitted to rotate relative to the bicycle frame. If the associated bicycle is intended for off road use, the bicycle frame may provide rear wheel suspension. Such a frame may include a main frame and sub-frame pivotally connected to the main frame. The sub-frame supports the rear wheel and a shock absorber may be connected between the main frame and the sub-frame to influence relative movement between the main frame and the sub-frame.

Commonly, when composite tubes are used in the construction of a bicycle frame it is at times desirable that the components that are bonded to the composite tubes be made of a different material such as an aluminum, magnesium, or steel. This is often common when bonding dropouts to seat stays or chain stays of a bicycle frame. The connection between the dropouts and the seat stays or chain stays is a particularly high-stress connection, which requires a relatively large contact surface area and proper adhesive application in order to obtain a strong connection.

Presently a dropout that can be bonded to a composite seat stay or chain stay and transmit disc brake loads is commonly large and overbuilt in order to transmit braking forces.

### SUMMARY OF THE INVENTION

Thus, a need exists for a lightweight dropout that can be bonded to a composite chain stay or seat stay and support and transmit disc brake loads.

A preferred embodiment is a bicycle frame dropout including an axle recess being capable of receiving at least a portion of an axle of a hub of a bicycle wheel. The dropout also includes a disc brake tab integrally formed with the dropout. A pivot bearing support is integrally formed with the dropout. A cavity is sized and shaped to receive a stay. The cavity includes a mounting interface, which comprises a first surface and a second surface facing the first surface. The first surface and the second surface are capable of permitting rotation of the stay relative to the dropout in a first rotational direction and opposing rotation of the stay relative to the dropout in a second rotational direction opposite the first rotational direction.

Another preferred embodiment is a bicycle frame lug including a cavity sized and shaped to receive a frame member. The cavity includes a mounting interface, which comprises a top surface, a bottom surface, a first side surface, a second side surface, and an end surface. The first side surface and the second side surface are capable of permitting lateral rotation of the frame member in a first rotational direction and opposing lateral rotation of the frame member in a second rotational direction opposite the first rotational direction. The end surface is capable of axially supporting the frame member within the cavity.

Yet another preferred embodiment is a bicycle frame including a main frame and a subframe pivotally connected to the mainframe. A frame component is attached to the subframe and includes a cavity sized and shaped to receive a portion of the subframe. The cavity includes a mounting interface, which comprises a top surface, a bottom surface, a first side surface, a second side surface, and an end surface. The first side surface and the second side surface are capable of permitting lateral rotation of the portion in a first rotational direction and preventing lateral rotation of the portion in a second lateral rotational direction opposite the first rotational direction.

An aspect of the present invention involves a method of attaching a bicycle frame tube to a frame component, including inserting the frame tube into a cavity of the frame component at an insertion angle that is not aligned with a longitudinal axis of the cavity and rotating the frame tube until the frame tube is substantially aligned with the longitudinal axis of the cavity and contacts both a first surface and a second surface defined by opposing wall portions of the frame component.

### BRIEF DESCRIPTION OF THE DRAWINGS

These and other features, aspects, and advantages of the present invention will now be described in connection with preferred embodiments of the invention, in reference to the accompanying drawings. The illustrated embodiments, however, are merely examples and are not intended to limit the invention. The drawings include the following eight Figures.

FIG. 1 is an illustration of an off-road bicycle, or mountain bike, which incorporates a dropout having certain features, aspects and advantages of the present invention.

FIG. 2A is a right side perspective view of the seat stay assembly of the off-road bicycle of FIG. 1

FIG. 2B is a left side perspective view of the seat stay assembly of the off-road bicycle FIG. 1

FIG. 3A is a left side perspective view of the dropout of the seat stay assembly of FIG. 2A.

FIG. 3B is left side, or non-drive side, view of the dropout of the seat stay assembly of FIG. 2A.

FIG. 3C is right side, or drive side, view of the dropout of the seat stay assembly of FIG. 2A.

FIG. 4 is a perspective view of the seat stay of the seat stay assembly of FIG. 2A being assembled with the dropout of the seat stay assembly of FIG. 2A.

FIG. 5 is a flow chart illustrating an assembly method of the dropout and the seat stay of the seat stay assembly of FIG. 2A.

### DETAILED DESCRIPTION OF THE PREFERRED EMBODIMENT

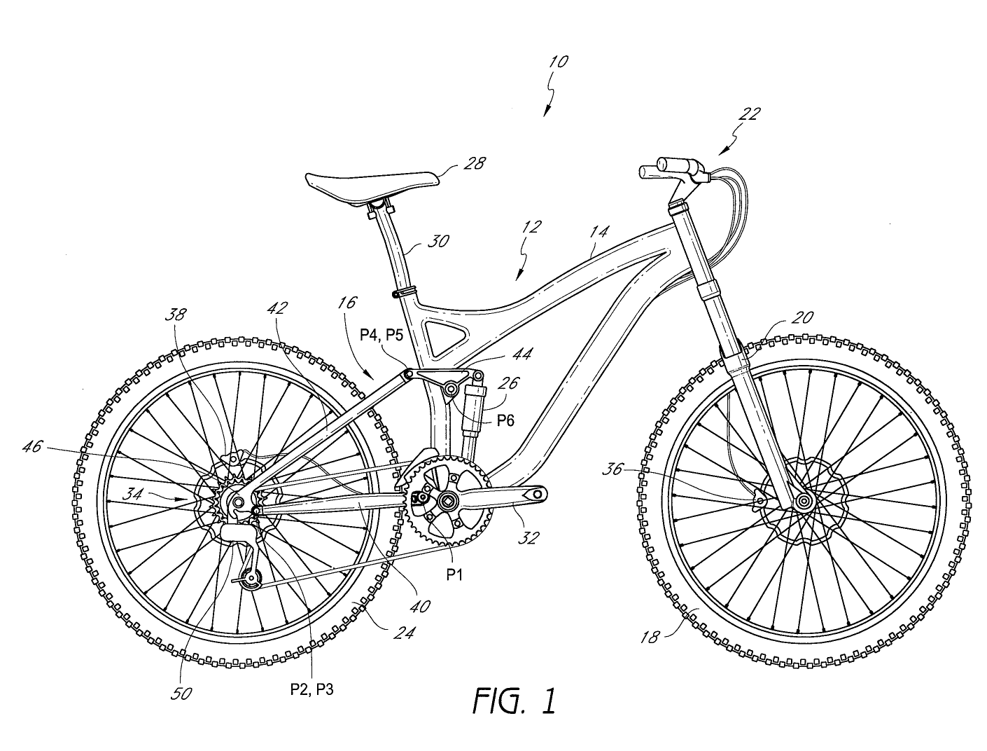

FIG. 1 illustrates an off-road bicycle, or mountain bike 10, including a preferred embodiment of a dropout. The bicycle 10 is described herein with reference to a coordinate system wherein a longitudinal axis extends from a forward end to a rearward end of the bicycle 10. A vertical, central plane generally bisects the bicycle 10 and contains the longitudinal axis. A lateral axis extends normal to the longitudinal axis and lies within a horizontal plane. In addition, relative heights are generally expressed as elevations relative to a horizontal surface on which the bicycle 10 is supported in an upright position. The above-described coordinate system is provided for the convenience of describing the bicycle illustrated in FIG. 1, and is not intended to limit the scope of the present invention. In addition, certain features and components of the bicycle 10 may be described in terms of relative positions or directions within the particular positions and orientations reflected in the drawings, which is merely for convenience and is not intended to limit the scope of the invention.

The bicycle 10 includes a frame 12, preferably comprised of a generally triangular main frame portion 14 and an articulating frame portion, or subframe 16. The subframe 16 is pivotally connected to the main frame 14. The bicycle 10 also includes a front wheel 18 carried by a front suspension assembly, or front fork 20. A steerer tube (not shown) is journaled for limited rotation about a steering axis defined by the main frame 14. The fork 20 is secured to the main frame 14 by a handlebar assembly 22, as is well known in the art. A rear wheel 24 of the bicycle 10 is carried by the subframe 16. A shock absorber 26 is pivotally connected to both the main frame 14 and the subframe 16 to provide resistance to the pivoting motion of the subframe 16 and, thus, provide resistance to the suspension travel of the rear wheel 24.

In addition, a seat 28 is connected to the frame 12 by a seat post 30, which is received within the seat tube of the main frame 14. The seat 28 provides support for a rider of the bicycle 10. A pedal crank assembly 32 is rotatably supported by the main frame 14 and drives a multi-speed chain drive arrangement 34, as is well known in the art. The bicycle 10 also includes front and rear brake systems 36, 38 for slowing and stopping the bicycle 10. Although the front and rear brakes 36, 38 are illustrated as disc type brakes, alternatively, rim type brakes may be provided, as will be appreciated by one of skill in the art. Rider controls (not shown) are commonly provided on the handlebar assembly 22 and are operable to control shifting of the multi-speed chain drive arrangement 34 and front and rear brake systems 36, 38.

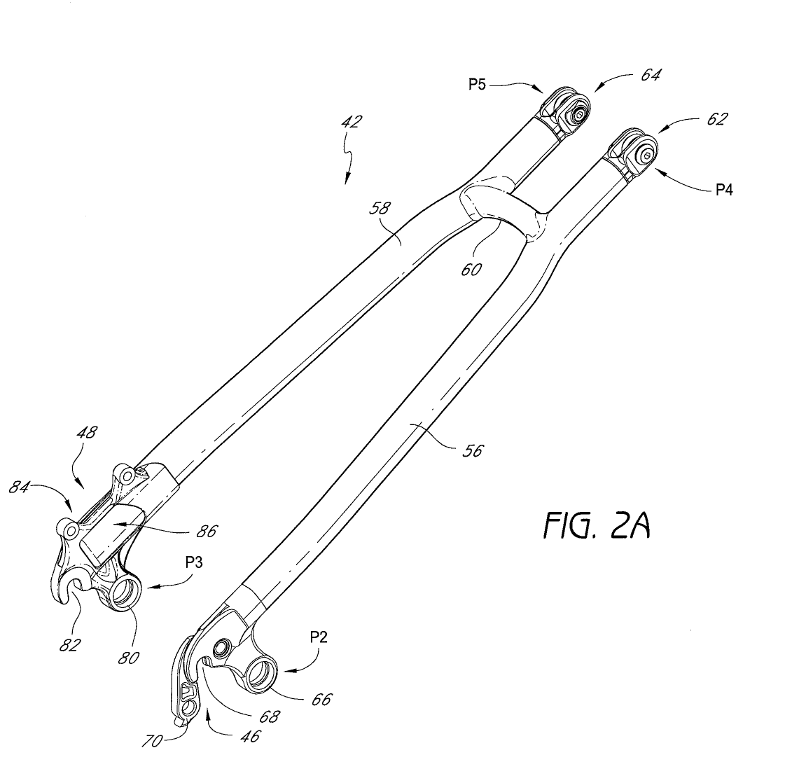

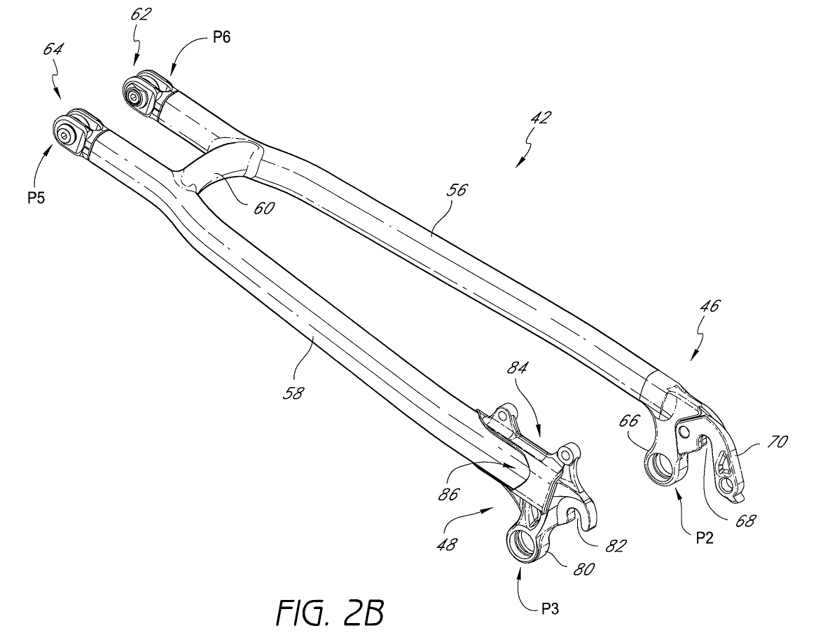

With reference to FIG. 1, 2A, and 2B the subframe 16 preferably comprises a chain stay assembly 40, a seat stay assembly 42, and a rocker link assembly 44. The chain stay assembly 40 preferably is connected to the main frame portion 14 at pivot P1. The chain stay assembly 40 is a yoke like assembly with two generally symmetrical legs that are located on opposing sides of the rear wheel 24. At the rearward ends of the chain stay assembly 40 are pivot locations P2 and P3 that pivotally connect the chain stay assembly 42 to the seat stay assembly 42. The seat stay assembly 42 comprises a similar general construction as the chain stay assembly 40 with the addition of two dropouts including a drive-side dropout 46 and a non-drive-side dropout 48 (see FIG. 2A and FIG. 2B). The dropouts 46 and 48 are configured to receive and axle of the rear wheel 24 and to also support a rear derailleur 50 and the rear brake system 38. The forward portion of the seat stay assembly 42 preferably includes the pivots P4 and P5 that are configured to pivotally connect the seat stay assembly 42 to the rocker link assembly 44. The rocker link assembly 44 preferably pivots about a pivot point P6 such that upward forces of the seat stay assembly 42 are transferred to downward forces that are relayed to the shock absorber 26.

FIGS. 2A and 2B illustrate perspective views of the seat stay assembly 42. The seat stay assembly 42 generally comprises a yoke shape and comprises a drive-side stay 56 and a non-drive-side stay 58. The drive-side stay 56 and the non-drive-side stay 58 preferably are connected by a connection arch 60 that couples the drive-side stay 56 to the non-drive side stay 58. The stays 58 and 56 preferably are constructed of a carbon fiber composite material in which the connection arch 60 is integrally molded with the stays 58 and 56. As will be appreciated by one skilled in the art, the stays 58 and 56 are not limited to a carbon fiber composite material and may be made of any suitable material including aluminum, magnesium, scandium, steel, fiberglass, or other suitable materials or combinations thereof.

Attached to the forward portion of each of the stays 56 and 58 preferably are pivot lugs 62 and 64 that are configured to pivotally attach the seat stay assembly 42 to the rocker link assembly 44. The pivot lugs 62 and 64 preferably are the outer portions of a clevis type pivot assembly in which portions of the rocker link assembly 44 are inserted into the pivot lugs 62 and 64. As will be appreciated by one skilled in the art, the pivot lugs 62 and 64 are one example of a suitable pivot types and other suitable pivot types may also be used. The pivot lugs 62 and 64 preferably comprise a portion of material that extends rearward so as to insert into the stays 56 and 58 such that the pivot lugs 62 and 64 have a certain amount of structural overlap with the stays 56 and 58.

The lugs 62 and 68, in some embodiments receive a large amount of force during normal operating conditions and also require a great deal of precision manufacturability in order to precisely couple to the rocker link assembly 44. Thus, it is preferable, in some embodiments, to construct the pivot lugs 62 and 64 of the metallic material such as aluminum, magnesium, scandium, or steal such that greater durability and precision can be achieved. This is particularly advantageous in that the seat stay assembly 42 can be a lighter assembly by using a carbon fiber or composite material to construct the stays 56 and 58 while reserving the heavier but more durable materials for the specific wear prone positions such as the pivot lugs 62 and 64 and the dropouts 46 and 48.

With continued reference to FIG. 2A and FIG. 2B, as briefly discussed above, the seat stay assembly 42 also preferably comprises two dropouts 46 and 48. The drive-side dropout 46 preferably comprises a pivot bearing support 66, an axle recess 68, and a replaceable derailleur hanger 70. The non-drive side dropout 46, which will be discussed in greater detail below, generally comprises a pivot bearing support 80, an axle recess 82, a disc brake tab 84, and a cavity 86 that is sized and shaped to receive the non-drive side stay 58.

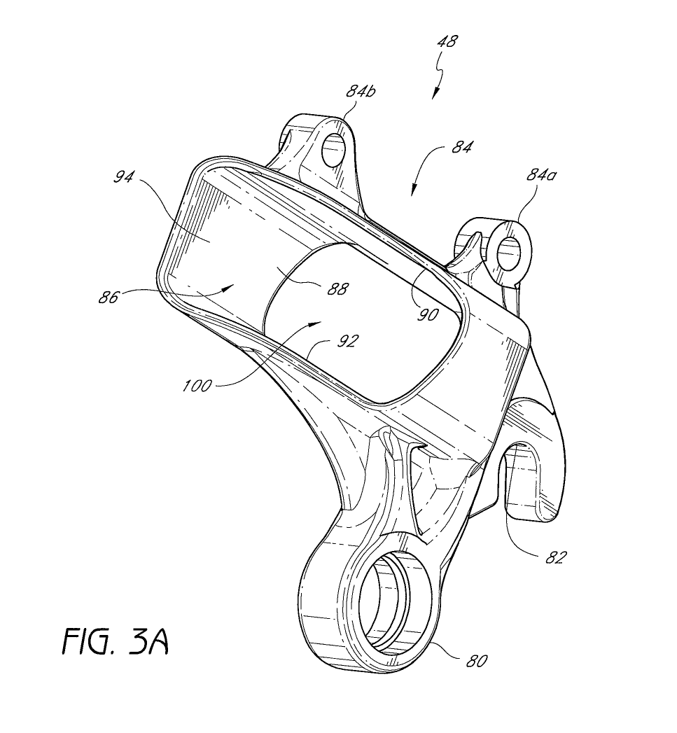

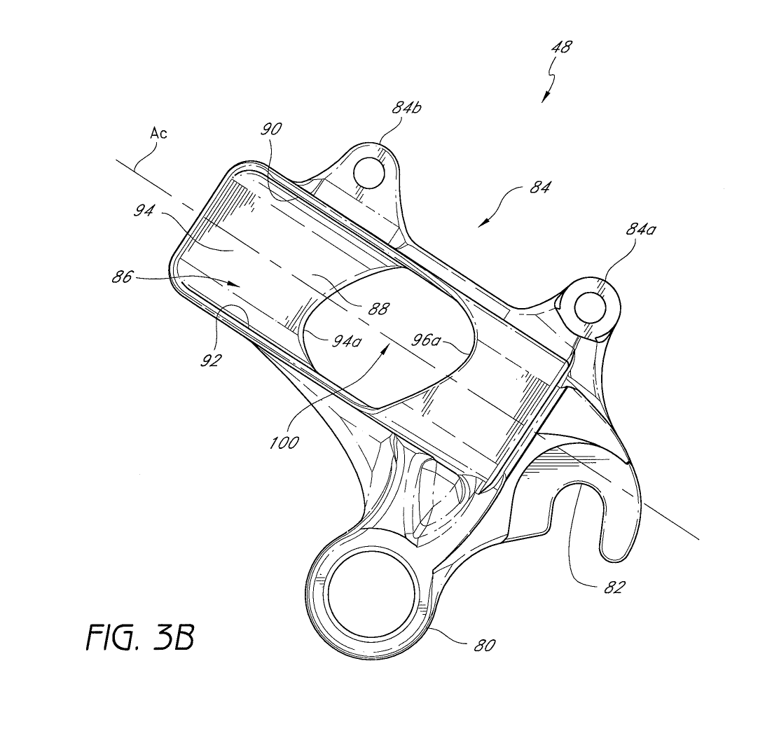

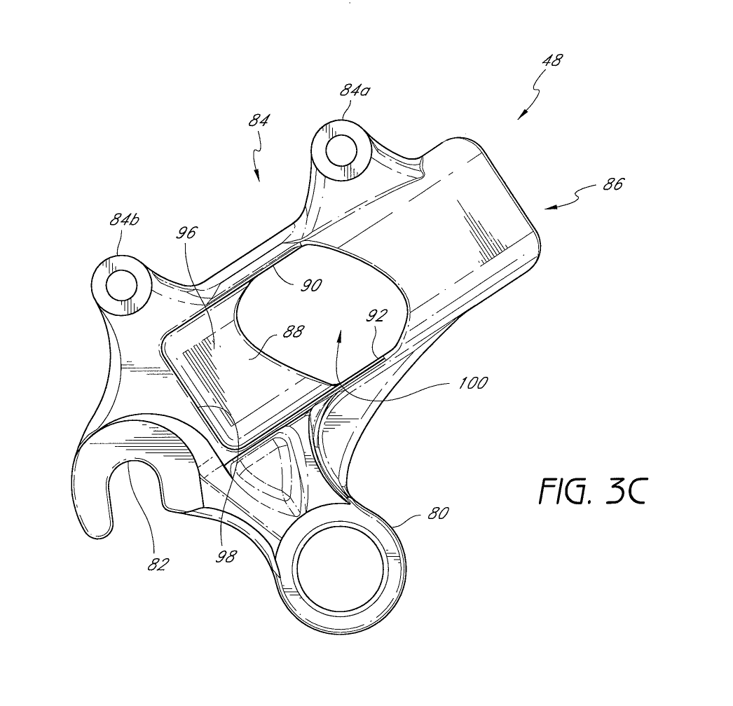

With reference to FIG. 3A-3C, an embodiment of the non-drive side dropout 48 is illustrated. As briefly described above, the non-drive side dropout 48 includes the pivot bearing support 80, the axle recess 82, the disc brake tab 84, and the cavity 86 that is configured to receive the non-drive side stay 58. The cavity 86 comprises a mounting interface 88 that is configured to mate with the outer surface of the non-drive side stay 58 when the non-drive side dropout 48 is installed on non-drive side stay 56. The mounting interface 88 preferably includes a top wall defining a top surface 90, a bottom wall defining a bottom surface 92, and two opposing side walls that define side surfaces 94 and 96. Furthermore, the mounting interface 88 also desirably includes an end wall defining an end surface 98 that is configured to support the end of the stay 58.

In the particular illustrated embodiment, the axle recess 82 preferably is a 10 mm quick release style axle recess such that a typical 10 mm hub axle may reside within the axle recess 82. As will be appreciated by one skilled in the art, the axle recess 82 may be of any suitable size, including that suitable for a 20 mm thru-axle or a 12 mm thru-axle. Furthermore, although the particular illustrated embodiment has been shown with a non-drive side dropout 48 that comprises both an axle recess 82 and an cavity 86 for mounting a non-drive side stay 58, in other embodiments the non-drive side dropout 48 may be configured such that it is attached to a chain stay with the disc brake tab 84 attached to a separate frame component. That is, in some embodiments, the non-drive side dropout 48 may comprise an axle recess, a cavity for the non-drive side stay, and a pivot bearing support, omitting the disc brake tab. In other embodiments the non-drive side dropout 48 may comprise a cavity for receiving a stay, a pivot bearing support, and a disc brake tab, omitting the axle recess. As will be appreciated by one skilled in the art this aforementioned alternative is commonly used with a four bar linkage in which the rear wheel hub is carried by the chain stay rather than the seat stay. Such a construction is often referred to as a “faux” four bar linkage in the bicycle industry.

In the particular illustrated embodiment, the disc brake tab 84 is a typical 51 mm international standard rear wheel disc brake tab that is configured to receive a typical 51 mm international standard disc brake caliper. As illustrated, the disc brake tab preferably comprises a forward or upper tab portion 84a and a rearward or lower tab portion 84b that cooperate to define the disc brake tab 84. Each of the tab portions 84a and 84b both preferably are configured to receive a 6 mm bolt that is typically used to attach a disc brake caliper. As will be appreciated by one skilled in the art, other suitable disc brake tabs may be used such as a 74 mm post mount or a 51 mm international standard tab that is configures to directly receive brake calipers for 4″, 6″, 7″, or 8″ disc rotors. Furthermore, in some embodiments the disc brake tab 84 may be omitted for such bicycle designs that do not use a disc brake but used a rim style brake or a coaster style brake.

In some embodiments, it is preferable to bond the stay 58 to the dropout 46 by a suitable adhesive. This can be particularly advantageous when the dropout 48 is made of a metal such as aluminum, scandium, steel, or magnesium and the non-drive side stay 58 is made of a composite such as carbon fiber or thermoplastic. When the non-drive side stay 58 is made of a composite it is highly unlikely that coalescence-type welding (e.g., arc welding) will be a suitable process to join the non-drive side dropout 48 to the non-drive side stay 58. Thus, as will be appreciated by one skilled in the art, using adhesive or other chemical joining processes can be particularly advantageous.

With continued reference to FIG. 3A-C, the mounting interface 88 is particularly advantageous in that it provides an excellent mounting interface 88 for the non-drive side stay 58 to contact the non-drive dropout 48. The top surface 90 and the bottom surface 92 desirably provide contact surfaces to the top and bottom sides of the non-drive side stay 58 such that rotational forces produced by a disc brake mounted to the disc brake tab 84 are effectively distributed to the non-drive side stay 56. In the illustrated embodiment, the top surface 90 and the bottom surface 92 preferably extend over a substantial portion of the cavity 86 such that the top mounting surface 90 in the bottom mounting surface 92 are in substantial contact with the non-drive side stay 56. This configuration provides rotational security to the stay 58 relative to the dropout 48 such the stay 58 cannot rotate vertically relative to the dropout 48 (or an axis A_{C} of the cavity 86) to any substantial extent.

The side surfaces 94 and 96 preferably are arranged in a spaced-apart configuration such that they face one another and are arranged such that they are at least partially offset along the axis A_{C} (FIG. 3B) with the side surface 94 being located generally above or forward of the side surface 96. Desirably, the side surfaces 94 and 96 are completely offset from one another such that they do not directly oppose or overlap one another along the axis A_{C}. In other words, a rearward edge 94a of the side surface 94 is spaced forward of a forward edge 96a of the side surface 96.

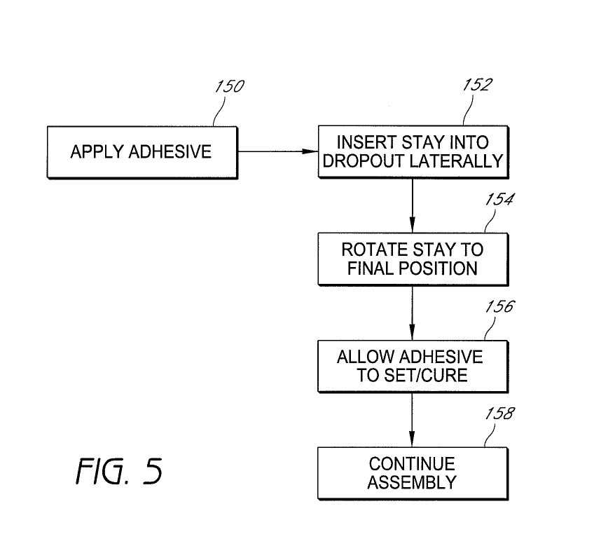

This arrangement of the side surface 94 and the side surface 96 also defines a stay opening 100 in which the non-drive side stay 58 can be inserted laterally through the non-drive side dropout 48 (see FIG. 5) and then rotated into position (see FIG. 2A) such that the non-drive side stay 58 is in axial alignment with the non-drive side dropout 40. As will be appreciated by one skilled in the art the opening 100 preferably is sized such that the stay can easily pass through the non-drive side dropout 48 so that sufficient distances can be maintained between the side opposing surface 94, the side opposing surface 96 and the side surfaces of the non-drive side stay 58 during insertion. The configuration of the mounting interface 88 helps reduce the likelihood of adhesive being wiped away from the respective mating surfaces of the stay 58 and the dropout 48 during insertion of the stay 58.

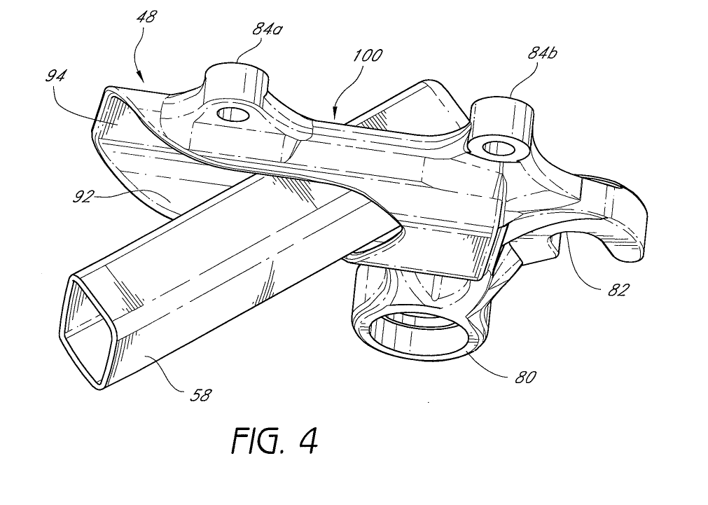

A method for installing the non-drive side dropout 48 onto the non-drive side stay 58 is described with reference to FIG. 4. Preferably, an adhesive is applied to some or all surfaces (e.g., surfaces 90, 92, 94, 96) of the mounting interface 88 of the non-drive side dropout 48 so as to prepare the mounting interface 88 for receiving the non-drive side stay 58. The non-drive side stay 58 is then laterally inserted through the stay opening 100 at a lateral angle relative to a final position of as illustrated in FIGS. 2A and 2B. After the non-drive side stay 58 has been inserted through the stay opening 100, the non-drive side stay 58 preferably is rotated to a final position such that a longitudinal axis of the non-drive side stay is at least substantially aligned with a longitudinal axis A_{C} of the cavity 86 of the non-drive side dropout 48. After the non-drive side stay 58 has been rotated into a final position, the assembly, comprising the non-drive side stay and be non-drive side dropout, preferably is allowed to cure so that the adhesive provides a desired level of bonding strength between the non-drive side stay 58 and the non-drive side dropout 48. Suitable curing can be achieved through drying at room temperature, through a chemical reaction such as that in the use of an epoxy, curing in an elevated or lowered temperature environment or any other suitable adhesive curing method.

The method of attaching the stay 58 to the dropout 48 is particularly advantageous in that the amount of adhesive that is wiped away during installation of the non-drive side stay 58 is substantially reduced. That is, in some prior art embodiments, a stay opening is provided in which a stay must be inserted into a recess or cavity such that the insertion angle is such that the longitudinal axis of the stay and the longitudinal axis of the recess are aligned during the insertion process. Thus, when adhesive is applied to such an arrangement a great deal of the adhesive is wiped away during insertion of the stay. With the above described embodiment, the non-drive side stay 48 can be inserted into the non-drive side dropout 58 by an insert and twist method while a substantial amount of adhesive is maintained in proper position on the mounting interface 88 such that an excellent bonding connection can be achieved.

Furthermore, the particular shape of the mounting interface 88 is also particularly advantageous in that it efficiently and effectively transfers torque to non-drive side stay 58 during operation, particularly with a disc brake caliper. That is, the shape of the mounting interface 88 is such that vertical rotation of the stay 58 is resisted by the shape of the dropout 48, in particular by the top and bottom wall surfaces 90, 92. This is particularly advantageous because this is the direction of the force that is quite often produced by a disc brake caliper. Furthermore, the mounting interface 88 is sized and shaped such that the stay can rotate laterally in one direction and lateral rotation in an opposite direction is substantially resisted or prevented. Once again, this is advantageous in that typically a dropout such as the non-drive side dropout 48 on a typical bicycle does not experience large amplitude lateral rotational forces and thus side rotational restraint provided by the adhesive is ample to maintain the non-drive side dropout 48 in a secured configuration with the non-drive side stay 58. However, in other applications, it may be desirably to insert the stay (or other frame tube or member) into the dropout (or other frame lug or component) in a different relative orientation. For example, in one arrangement, the top and bottom surfaces could be offset from one another such that the stay is inserted at an angle with the dropout cavity in a vertical direction and rotated vertically upward or downward into position within the cavity. In other arrangements, the walls defining the cavity may not be arranged in a top, bottom, left, right fashion, but may be rotated therefrom. Furthermore, the walls defining the cavity may include rounded or circular surfaces, rather than the generally flat surface shown herein.

Another particular advantage provided by the mounting interface 88 of the non-drive side dropout 48 described above is the ease at which the non-drive side dropout 48 can be manufactured. Due to the open nature of the mounting interface 88 when the non-drive side dropout 88 is to be manufactured it can easily be forged using conventional methods such that minimal amounts of post-forge machining are needed to finalize the mounting interface 88 or any other of the attributes of the non-drive side dropout 48. Furthermore, if one were to prefer a machining manufacturing method, that too could be more easily achieved in that the open nature of the mounting interface 88 is once again easily accessible for machining using, for example, a rotary machining tool. The prior art dropouts that use a laterally enclosed opening to receive a stay are very difficult and costly to machine the opening. Furthermore, in some prior art embodiments it is nearly impossible to forge the opening to receive the stay.

FIG. 5 is a flow diagram that illustrates a preferred assembly method that may be used with some of the foregoing embodiments. At block 150, an adhesive is applied to the mounting interface 88 of the dropout 46. As described above the, adhesive can be any suitable adhesive in including for example an epoxy. At block 152, the stay 58 is inserted laterally into the dropout 48. As described above, this is particularly advantageous in that any wiping away of adhesive that may have been applied at block 150 is reduced during the insertion process. At block 154 the stay is rotated to a final position. At block 156 the adhesive is allowed to set or cure such that a connection of desired strength is achieved between the dropout 48 and stay 58. At block 156 the remainder of the assembly is continued. This may include installing other components such as the seat stay assembly 42 or further assembly of the bicycle frame 12.

Although the above described embodiment with reference to the figures has been described with reference to a non-drive side dropout 48, other suitable embodiments are also within the scope of the technology. For example, as will be appreciated by one skilled in the art, the mounting interface 88 can be employed with a wide variety of frame components including fork dropouts, bottom bracket lugs, frame tube juncture lugs, seat post clamps, head tube lugs, drive side dropout's, suspension pivot eyelet lugs, or other suitable frame components, including fork leg-to-lug connections. Furthermore, as will be appreciated by one skilled in the art, the mounting interface 88 can be used with a dropout or frame lug on any full suspension frame or hardtail frame. The above disclose technology can equally be used with, what is vernacularly referred to in the art as, a Horst Link or a non-Horst Link, or faux link, style suspension frame. Also, the above described technology can be equally used with frame components such as dropouts on single pivot style suspension frames.

Furthermore, although the above described embodiment has been disclosed with reference to a metallic frame component and a composite frame tube, the technology can just as easily be used with a metallic frame tube and a metallic frame component that may be welded or bonded together, or a composite frame tube and a composite frame component that may be bonded together as described above.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while the number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with, or substituted for, one another in order to perform varying modes of the disclosed invention. Thus, it is intended that the scope of the present invention herein disclosed should not be limited by the particular disclosed embodiments described above, but should be determined only by a fair reading of the claims.

What is claimed is:

1. A bicycle frame dropout comprising:
an axle recess, said axle recess being capable of receiving at least a portion of an axle of a hub of a bicycle wheel;
a disc brake tab, said disc brake tab integrally formed with said dropout;
a pivot bearing support, said pivot bearing support integrally formed with said dropout; and
a cavity sized and shaped to receive a stay, said cavity comprising a mounting interface, said mounting interface comprising a first surface and a second surface facing said first surface, said first surface and said second surface being capable of permitting rotation of the stay relative to said dropout in a first rotational direction and opposing rotation of the stay relative to said dropout in a second rotational direction opposite said first rotational direction.

2. The bicycle frame dropout of claim 1, wherein said first and second rotational directions are lateral directions from a longitudinal axis of said cavity.

3. The bicycle frame dropout of claim 1, wherein said first surface and said second surface are offset from one another along a longitudinal axis of said cavity such that at least a portion of each said first and second surfaces is unopposed by the other.

4. The bicycle frame dropout of claim 1, wherein said first surface and said second surface are defined by side walls of said dropout.

5. The bicycle frame dropout of claim 4, wherein said first surface and said second surface extend continuously between a top surface and a bottom surface defining said cavity.

6. The bicycle frame dropout of claim 1, wherein said dropout further comprises an end surface being capable of axially supporting the stay within the cavity.

7. The bicycle frame dropout of claim 1, wherein said dropout is made of metal.

8. The bicycle frame dropout of claim 7, wherein said dropout is made of aluminum.

9. A bicycle frame lug comprising:
a cavity sized and shaped to receive a frame member, said cavity comprising a mounting interface, said mounting interface comprising a top surface, a bottom surface, a first side surface, a second side surface, and an end surface, said first side surface and said second side surface being capable of permitting lateral rotation of the frame member in a first rotational direction and opposing lateral rotation of the frame member in a second rotational direction opposite said first rotational direction, said end surface being capable of axially supporting the frame member within the cavity.

10. The bicycle frame lug of claim 9, wherein said first side surface and said second side surface are offset from one another along a longitudinal axis of said cavity such that at least a portion of each said first and second side surfaces is unopposed by the other.

11. The bicycle frame lug of claim 10, wherein an entirety of each of said first and second side surfaces are unopposed by the other.

12. The bicycle frame lug of claim 9 further comprising a disc brake tab, said disc brake tab being integrally formed with said frame component.

13. The bicycle frame lug of claim 12, wherein said disc brake tab is a 51 mm international standard disc brake tab.

14. The bicycle frame lug of claim 9, further comprising a pivot bearing support, said pivot bearing support being integrally formed with said frame component.

15. The bicycle frame lug of claim 9, further comprising an axle recess, said axle recess being integrally formed with said frame component.

16. The bicycle frame lug of claim 9, wherein said frame lug is made of metal.

17. A bicycle frame comprising:
a main frame;
a subframe pivotally connected to said mainframe;
a frame component attached to said subframe, said frame component comprising a cavity sized and shaped to receive a portion of said subframe, said cavity comprising a mounting interface, said mounting interface comprising a top surface, a bottom surface, a first side surface, a second side surface, and an end surface, said first side surface and said second side surface being capable of permitting lateral rotation of said portion in a first rotational direction and preventing lateral rotation of said portion in a second lateral rotational direction opposite said first rotational direction.

18. The bicycle frame component of claim 17, wherein said first side surface and said second side surface are offset from one another along a longitudinal axis of said cavity such that at least a portion of each said first and second side surfaces is unopposed by the other.

19. The bicycle frame of claim 18, wherein an entirety of each of said first and second side surfaces are unopposed by the other.

20. The bicycle frame of claim 17, wherein said frame component is made of metal.

21. The bicycle frame of claim 17, wherein said subframe is at least partially made of a composite.

22. The bicycle frame of claim 17, wherein said subframe is bonded to said frame component using an adhesive.

23. The bicycle frame of claim 17, wherein said frame component comprises an axle recess, said axle recess being integrally formed with said frame component.

24. The bicycle frame of claim 17, wherein said frame component comprises a disc brake tab, said disc brake tab being integrally formed with said frame component.

25. The bicycle frame of claim 17, wherein said frame component comprises a pivot bearing support, said pivot bearing support being integrally formed with said frame component.

26. A method of attaching a bicycle frame tube to a frame component comprising:
inserting the frame tube into a cavity of the frame component at an insertion angle that is not aligned with a longitudinal axis of the cavity; and
rotating the frame tube until the frame tube is substantially aligned with the longitudinal axis of the cavity and contacts both a first surface and a second surface defined by opposing wall portions of the frame component.

27. The method of claim 26, further comprising applying an adhesive to said frame component.

28. The method of claim 26, further comprising welding said frame component to said frame tube.
